(19) United States
(12) Patent Application Publication
(10) Pub. No.: US 2024/0067823 A1
(43) Pub. Date: Feb. 29, 2024

(54) Colloidal lignin-epoxy formulations

(71) Applicant: Aalto University Foundation sr, Aalto (FI)

(72) Inventors: Tao Zou, Espoo (FI); Monika Österberg, Espoo (FI); Mika Sipponen, Solna (SE); Alexander Henn, Espoo (FI)

(21) Appl. No.: 18/268,319

(22) PCT Filed: Dec. 21, 2021
(86) PCT No.: PCT/FI2021/050905

§ 371 Date: Jun. 20, 2023

(30) Foreign Application Priority Data
Dec. 21, 2020 (FI) 20207196

(51) Int. Cl. C08L 97/00; C08G 59/24; C08J 3/14; C08K 5/19; C09J 7/25; C09J 163/00; C09J 197/00

(52) U.S. Cl. CPC C08L 97/005; C08G 59/245; C08J 3/14; C08K 5/19; C09J 7/25; C09J 163/00; C09J 197/005; C09J 2301/30; C09J 2463/00; C09J 2497/00

(57) ABSTRACT

The invention describes a method of forming aqueous lignin-epoxy hybrid nanoparticles with switchable surface characteristics. The invention is applicable to production of technical adhesives and covalent surface modification of lignin nanoparticles under harsh reaction conditions. Further, in terms of the covalent functionalization of lignin nanoparticles (LNPs), this invention presents the covalent cationization of LNPs by means of attached quaternary ammonium groups.

### FIELD OF THE INVENTION

The invention belongs to the field of technical use and preparation of nanomaterials. The invention describes a method of forming aqueous lignin-epoxy hybrid nanoparticles with switchable surface characteristics. The invention is applicable to production of technical adhesives and covalent surface modification of lignin nanoparticles under harsh reaction conditions.

### BACKGROUND OF THE INVENTION

The invention can be applied in applications, such as technical adhesives and covalent modification of lignin nanoparticles under harsh conditions such as in strongly alkaline pH or common organic solvents.

In the field of technical adhesives, petroleum-based formaldehyde adhesives have been dominating the wood adhesive markets. However, formaldehyde has toxicity and environmental problems, and petroleum is a non-renewable source. Today, our society is transitioning to a stronger, circular and low-carbon economy, namely bioeconomy that is supported by the European Commission among others, which requires a greener and more sustainable use of natural resources by sustainably increasing the primary production and conversion of waste into value-added products, enhanced production and resource efficiency. Lignin, as a non-toxic, environmentally friendly, renewable and abundant material extracted from plant biomass, is a perfect example that meets the target of bioeconomy strategy. Hence, study on lignin has emerged in recent years, aiming to partially replace petroleum-based products. Among the various potential applications of lignin, technical adhesives represent a high-volume application.

In recent years, numerous studies have reported the use of lignin as an adhesive, however, most of the previous reports are related to formaldehyde-based adhesives, i.e. replace phenols partially with modified lignin to form phenol-lignin-formaldehyde type adhesives (see Podschun, J. et al. and Kalami, S. et al.). To avoid the use of formaldehyde, some studies reported lignin-epoxy adhesives. However, fractionation or degradation or functionalization of lignin is usually required, e.g. amination of lignin as a hardener for epoxy resin or the solution state epoxidation of lignin for preparing lignin-based epoxy resins (see Jablonskis, A. et al.; Zhang, Y. et al.; Ott, M. W. et al. and Gioia, C. et al.). Only a few studies have reported the lignin-epoxy adhesives in which fractionation or degradation or functionalization of lignin is not required. For instance, Li et al. mechanically blended Kraft lignin and glycerol diglycidyl ether (GDE) with the presence of water and used it for plywood adhesives (see Jingxian Li, R. et al.). Henn et al. used aqueous colloidal lignin particles (or lignin nanoparticles, as described in WO2019081819A1), that are mechanically mixed with GDE for application as surface coatings or technical adhesives (see Henn, A.). Yet, the current price of GDE is still high due to its limited supply.

This invention provides a new method to prepare lignin-epoxy adhesives. Firstly, the invention overcomes the technical barriers mentioned above as there is no need for fractionation or degradation or functionalization of the lignin. Kraft lignin can be used as such. Secondly, the prepared lignin-epoxy adhesive is an “all-in-one” formulation containing no volatile organic compounds, which can be directly and easily applied on e.g. wood without pre-mixing or stepwise spreading. The adapted epoxy is bisphenol A diglycidyl ether (BADGE), which is one of the most used commercial epoxy resins. BADGE-based products have been criticized for their safety issues due to the migration of BADGE or BADGE derivatives or traces of biphenol A into environment, e.g. from cans to food. However, this invention is not aiming for applications related to food or drink. More importantly, the strong non-covalent association of BADGE and lignin would prevent the migration of BADGE into the environment. In addition, the invention describes formulations in which BADGE is a minor component, and lignin is the major component. After a complete reaction of BADGE with the hydroxyl groups of lignin, there is no migration problem anymore.

BADGE is highly suitable for use as a crosslinker in hybrid lignin nanoparticles (hy-LNPs), because it is hydrophobic and shares a structural resemblance with the aromatic dimers present in softwood Kraft lignin (SKL).

Another important benefit of this invention is that the lignin-epoxy adhesive shows strong water-resistance after curing, whereas the water-resistance of commercial epoxy adhesives are normally poor and the poor water resistance of lignin-based phenol formaldehyde resins is one reason why their use have been limited and the phenols can only be partly replaced (see Frihart, C. R.).

Intraparticle crosslinking has also been shown to provide resistance of the particles to dissolution in a binary solvent, such as acetone-water, and at a high pH, preferably being >10, such as pH 12, enabling their chemical functionalization by epoxy ring opening chemistry.

Also as the benefit of the invention is the relative green and simple process of forming lignin-epoxy adhesives, in which the only needed organic solvent is acetone that can be recycled.

In terms of the covalent functionalization of the lignin nanoparticles (LNPs, also called colloidal lignin particles), this invention presents for the first time the covalent cationization of LNPs by means of attached quaternary ammonium groups. LNPs are soluble in common organic solvents (e.g. acetone, ethanol or tetrahydrofuran) or under highly alkaline conditions (e.g. at pH>10) (see Lievonen, M. et al.; Sameni, J. et al. and Richter, A. P. et al.), thus hampering their covalent functionalization using commercial reaction routes such as epoxy ring-opening or Mannich chemistries. This invention solves the poor stability problem of LNPs by intraparticle-crosslinking of the particles. Covalent cationization was applied to the modified LNPs under strongly alkaline conditions and the resulted particles showed pH-switchable surface change. Previously, cationization of LNPs could only be achieved by physical adsorption of cationic polymers/oligomers, e.g. with poly(diallyldimethylammonium chloride), cationic lignin or chitosan (see Lievonen, M. et al.; Sipponen, M. H. et al. and Zou, T. et al.). Cationization of LNPs has expanded the application fields of LNPs, for instance, for biocatalysis, virus removal and Pickering emulsions (see Sipponen, M. H. et al. 2017; Zou, T. et al.; Sipponen, M. H. et al. 2018 and Rivière, G. N. et al.). Compared to the physical cationization of LNPs, the covalent cationization of LNPs may further broaden the application of lignin, since the covalently cationized LNPs presented herein have the advantages of pH stability and ion exchange resistance when subjected to salt solutions.

The solvent-resistant hy-LNPs are the main highlights, which can be used for various covalent surface functionalization under harsh conditions (e.g. at pH 12). The covalent cationization of the solvent-resistant hy-LNPs and the resulted pH-switchable surface charge is one example of the covalent surface functionalization, that is achieved by using epoxy ring-opening reaction under strongly alkaline conditions which is not possible for regular LNPs.

The robust CLPs prepared by the method described above can be functionalized or used under harsh conditions that would dissolve traditional CLPs or c-CLPs.

As a side note: One can (in theory) also prepare cationic CLPs by first cationizing lignin and then form the particles. However, this doesn't work very well since only very low charge densities can be obtained, since high charge density leads to solubility in water. This was demonstrated and explained in ref. 14 Sipponen et al. 2017 Green Chem.

### SUMMARY OF THE INVENTION

This invention enables to prepare in an unique way stable colloidal lignin particles with size of below one micrometer.

The invention provides a method of forming aqueous lignin-epoxy hybrid nanoparticles. In particular, the invention involves the use of softwood Kraft lignin (SKL) and bisphenol A diglycidyl ether (BADGE). SKL and BADGE are physically mixed together in solution state and co-precipitated by reducing the solvent concentration in the mixture to give rise to SKL-BADGE hybrid nanoparticles (hy-LNPs). Depending on the mass ratio of SKL to BADGE, the hy-LNPs can either be intraparticle-crosslinked for covalent surface functionalization or inter- and intraparticle cross-linked for technical adhesives.

Typically, the BADGE acts as a crosslinker, whereby the SKL and the BADGE are crosslinked to provide strong adhesion. The crosslinking can be achieved by selecting suitable curing conditions, as detailed below.

After mixing the SKL and the BADGE together in solution, undissolved residues may be removed, preferably by filtering, e.g. by passing the solution through paper filters.

The concentration of BADGE in the formed hy-LNPs is preferably 10-50 wt %, a concentration of ≤20 wt %, or especially about 20 wt %, being particularly preferred for particles intended for covalent surface functionalization due to the high particle integrity of these particles, and a concentration of ≥30 wt % being particularly preferred for particles intended for adhesives due to their uniform size distribution.

Reducing solvent concentration in the mixture of SKL and BADGE in the solution typically refers to the reduction of the concentration of the organic solvent, and is preferably done by rapid co-precipitation of SKL and BADGE against water, particularly by rapidly mixing the solution into water, e.g. as described below by rapid mixing (preferably in less than 1 s) under vortex stirring of water. This coprecipitation will result in the formation of the hy-LNPs. The organic solvent may be removed afterwards by separation methods, such as dialysis against water or evaporation.

A curing step is preferred in order to obtain the finished product, as described below. Curing, among others, finishes the chemical reaction between lignin and epoxy, and typically takes place by increasing the temperature and adjusting the pH of the hy-LNP dispersion. Water behaves as a catalyst for the reaction between lignin and epoxy.

The curing temperature is pH dependent, i.e. for a higher pH a lower curing temperature is needed. For the below described embodiments, the curing pH can vary from 4 to 12, while the temperature can be seen to vary between room temperature and 160° C.

Meanwhile, the higher the curing temperature, the shorter the curing time is required, with the below embodiments mentioning curing times of 0.5-8 h, for example 4h, or even as short as 10 min.

The colloidal lignin particles prepared by the method can be used as adhesives for instance for wood derivates. Alternatively, the adhesives can be used to glue substrates, such as wood, ceramics or metals, or to glue more than one of these substrates to each other. The adhesive strength is excellent after curing of the adhesive, especially the wet adhesive strength is significant higher compared to a commercial epoxy adhesive, revealing the good water resistance of the adhesive. Preferably, the adhesive is a waterborne adhesive.

The concentration of the aqueous hy-LNP dispersion intended for the adhesive should be relatively high, e.g. at 20-40 wt % of the solid content, to achieve a good adhesive strength. For the adhesives, the curing can be done at the native pH of the dispersion (e.g. at pH 4), and with the curing temperature at ambient pressure being at or above 160° C., as high temperature can extrude the epoxy out of the particles to achieve both inter- and intraparticle cross-linking reactions. Lower curing temperature (20-100° C., depending on pressing force and curing time) can be achieved at a higher pH, e.g. from pH 7 to 10. However, the pH adjustment is preferably done right before the use to avoid significant reaction of lignin and epoxy before applying the adhesive to the substrate. Thus, it is preferred also to carry out the curing, for adhesive purposes, after applying the dispersion onto a substrate.

The curing for covalent cationization is intended to achieve intraparticle cross-linking, and can be done, using the hy-LNP dispersions, at an elevated temperature, e.g. from 90 to 120° C., at the native pH (4 to 6) of the hy-LNP dispersion, or at a lower curing temperature, e.g. from 30 to 90° C. at a pH between 7 and 10, or at room temperature at pH 12. Typically, complete intraparticle cross-linking can be achieved within 4 h.

The colloidal lignin particles hy-LNPs can be subjected to covalent surface modification under harsh conditions, for instance in common organic solvents or under highly alkaline conditions (e.g. at pH 12). This further functionalization of hy-LNPs expands utilization capacity towards various applications. As an example, we demonstrated the covalent cationization of the hy-LNPs at pH 12 and obtain cationized hy-LNPs that exhibit pH-switchable surface charge. The cationized hy-LNPs can be used for instance as emulsifiers, carriers for enzymes for biocatalysis or biosensors or absorbents under different environments. Beyond the cationization of the hy-LNPs, other covalent modification of the hy-LNPs can also be done using for instance epoxy ring-opening or Mannich reaction routes in common organic solvents or under strongly alkaline conditions.

Potential applications of the cationized particles are as follows:
Adsorption: water purification, enzyme immobilisation, retention aids in fibreboard production
Emulsifiers: potentially reusable unlike water-soluble cationic lignin
Dispersants: especially for cationic polymers and particles (e.g. cationic clay)

### BRIEF DESCRIPTION OF THE DRAWINGS

Table 1. Preparation parameters, final obtained concentrations and yields of the BADGE-SKL hybrid LNPs and the regular LNPs.

FIG. 1. Size distribution, morphology and zeta potential of the hy-LNPs (BADGE content: 10 to 50 wt %) and the regular LNPs (0 wt % BADGE). (a) Average hydrodynamic diameters (Dh), zeta potentials and polydispersity indices (PDI) of the particles. (b) Intensity-based hydrodynamic diameter distributions of the particles. (c) AFM-height images of the particles (scale bar: 400 nm). (d) TEM images of the hy-LNPs30, hy-LNPs40 and hy-LNPs50 (Scale bar: 400 nm), selected core-shell structure particles are indicated by the black arrows. FIG. 1 shows the morphologies, hydrodynamic diameters and zeta potentials of the various hy-LNPs (10 to 50 wt % BADGE) and the regular hy-LNPs. The hydrodynamic diameters (Dh, also called Z-average size) and zeta potentials were measured at the native concentration (˜0.2 wt %) and diluted concentration (˜0.02 wt %, diluted 10 times with deionized water) of the dispersions respectively, a Zetasizer Nano ZS90 instrument (Malvern Instruments Ltd., U.K.) was adapted for the measurement. The pH of the diluted dispersions varied between 5 and 6. Average values of three replicates of the Dh and zeta potentials were used in the analysis and reporting of data. A MultiMode 8 atomic force microscope (AFM) equipped with a NanoScope V controller (Bruker Corporation, U.S.A.) was used to take the AFM images. Transmission electron microscopic (TEM) images of the hy-LNPs were obtained in bright-field mode on a FEI Tecnai 12 (USA) operating at 120 kV.

FIG. 2 Intraparticle-curing of the hy-LNPs20 in dispersion state (— 0.2 wt %) and the resistance of the (4 h) cured particles against dissolution in acetone-water (3:1, w/w) and different pH, as well as their thermal stabilities. (a) AFM height images of 0.5 to 8 h cured hy-LNPs20, samples were measured before and after rinsing with acetone-water (3:1, w/w) (Scale bar: 400 nm). (b) QCM-D results of the in-situ adsorption of the cured, uncured hy-LNPs20 and the regular LNPs, and their response to the pH between 5 to 12. Poly-L-lysine (PLL) was used as anchoring polymer for particle adsorption to gold substrates, and hence the response of PLL to pH change was also monitored. (c) AFM height images show particle morphology of the dried samples after QCM-D ex-periments (i.e. after treatment at pH 12). The scale bar is 400 nm. (d) Residual mass (%) and first derivative of the residual mass of the dry particles determined with TGA at a heating rate of 10° C./min. FIG. 2 shows solvent-resistance and thermal stabilities of the 0.5 to 8 hour-cured hy-LNPs20. The 4 h cured particles withheld their integrities after rinsing with acetone-water (3:1, w/w) in contrast to the particles cured for shorter times that showed clear reduction in size. In addition, the 4 h cured particles (shorted as cured particles in the figure) exhibited ˜20% reduction in sensed mass at pH 12 as detected by quartz crystal microbalance with dissipation monitoring, whereas regular LNPs showed a sharp reduction in sensed mass back to around zero. Atomic force microscopic images confirmed the pH-resistance of the cured hy-LNPs20, and a complete dissolution of the regular LNPs at pH 12. Moreover, the cured hy-LNPs20 exhibited significantly higher T_{5%} (5% mass loss) of 290° C. compared to the T_{5%} of 256° C. for the regular LNPs. The uncured hy-LNPs20 showed similar thermal stability as the cured hy-LNPs20 due to curing upon heat treatment.

FIG. 3. (a) Average hydrodynamic diameter (DO and zeta potential of the cationized cured hy-LNPs20 plotted against pH. The shaded area marks the surface charge transition of the cationized particles. (b) AFM height image shows the particle morphology of the cationized particles obtained at pH 2.3 (scale bar: 400 nm). FIG. 3 shows the pH-switchable surface charge of the cationized particles. The size of the cationized particles was similar to that before cationization as indicated by the atomic force microscopic images.

FIG. 4. (a) Adhesive strength of the hy-LNPs30-based waterborne adhesive (41 wt % solid content) and a commercial epoxy adhesive from Loctite for birch veneers (11.5×2×0.15 cm3). Mean±standard error of three replica are shown. The dashed lines denote the minimum dry/wet adhesive strength requirements for urea-formaldehyde type adhesive according to ASTM-D4690. (b) Photographic profile and SEM images of the glued area (20×5 mm2) after adhesive test. FIG. 4 shows the dry and wet adhesive strength of the hy-LNPs30-based waterborne adhesive (41 wt % solid content) and a commercial epoxy adhesive from Loctite for birch veneers (11.5×2×0.15 cm³). Mean±standard error of three replica are shown. The dashed lines denote the minimum dry/wet adhesive strength requirements for urea-formaldehyde type adhesive according to ASTM-D4690. After curing the hy-LNPs30 formed thermoset as indicated by the scanning electron microscopic images.

### DETAILED DESCRIPTION OF EMBODIMENTS

### Definitions

The term “lignin nanoparticle” (LNP, plural LNPs), or “colloidal lignin particle” (CLP, plural CLPs) refer to spherical lignin particle that have the hydrodynamic diameter (or Z-average size, determined with Zetasizer) in the range of dozens to hundreds of nanometers, as described in WO2019081819A1. Hence, LNP is used interchangeably with CLP.

The term “lignin-epoxy hybrid nanoparticle” (hy-LNP, plural hy-LNPs) in this context refers to spherical nanoparticles containing both softwood Kraft lignin (SKL) and bisphenol A diglycidyl ether (BADGE).

The term “epoxy” refers to epoxy resins, which are based on compounds that contain epoxy groups, such as the ethers named herein, i.e. bisphenol A diglycidyl ether, resorcinol diglycidyl ether or bisphenol F diglycidyl ether.

The “solvent” used in the preparation of the by-LNP dispersions is typically a monomorphic organic solvent, such as the above mentioned acetone or tetrahydrofuran, or a binary or ternary solvent mixture, formed e.g. by the organic solvent and the non-solvent water, the binary acetone-water mixture being preferred, whereby the only needed organic solvent is acetone that can be recycled. A particularly suitable solvent mixture is an acetone-water mixture, prepared at a mass ratio of 3:1.

The numbers added after hy-LNPs denote the weight percentage of BADGE relative to SKL. For instance, hy-LNPs10 means that the weight percent of BADGE is 10 wt % relative to SKL.

The hydrodynamic diameter of the hy-LNPs vary from 10 to 1000 nm.

The zeta potentials of the hy-LNPs vary between −20 and −40 mV, the values are measured at the native pH between 4 and 6.

The concentrations mentioned in this context are all in weight percentages, and the ratios are mass ratios if not otherwise stated.

The terms “curing” and “cured” in this context refer to the ongoing (=curing) and finished (=cured) process of the chemical reaction between lignin and epoxy. Further, the curing conditions have an effect on the crosslinking of the particles, taking place either as intraparticle cross-linking or as both intraparticle and interparticle crosslinking.

The terms “intraparticle cross-linking” and “interparticle cross-linking” refer to the reaction between lignin and epoxy taking place inside of the hy-LNPs and outside of the hy-LNPs respectively. Thus, the interparticle crosslinking involves the extrusion of the epoxy out of the hy-LNP particles.

The pH-switchable surface charge of the covalently cationized particles is intended to mean that they are positively charged at a low pH, such as at below pH 4, but negatively charged at a high pH, such as at pH>6.5.

The term “room temperature” in this context, particularly used when referring to evaporation, curing or intraparticle cross-linking, refers to the temperature around 23° C., but can also vary e.g. from 15 to 30° C.

### DESCRIPTION OF INVENTION

In one embodiment, the present invention provides a method of preparing lignin-epoxy hy-LNPs. In this context, lignin can be any lignin extracted from plant via e.g. Kraft process, biorefineries or enzymatic hydrolysis. One example is softwood Kraft lignin (SKL) that purified from black liquor using LignoBoost@ technology. Epoxy can be any epoxies, preferably water-insoluble, containing at least two epoxy groups in one molecule, preferably but not necessarily with benzene rings in the chemical structure and preferably but not necessarily with low molecular weight (or with high functionalities). Examples can be bisphenol A diglycidyl ether, resorcinol diglycidyl ether or bisphenol F diglycidyl ether.

In one embodiment, the lignin-epoxy hy-LNPs are prepared with nanoprecipitation method. First, lignin and epoxy are dissolved in a monomorphic, binary or ternary solvent, e.g. acetone, tetrahydrofuran, ethanol or acetone-water, tetrahydrofuran-water, ethanol-water, acetone-ethanol-water, or tetrahydrofuran-ethanol-water, acetone-tetrahydrofuran-water. In case of binary solvent, the mass ratio of organic solvent to water can vary from 10:1 to 1: 1, preferably 3:1. The concentrations of lignin and epoxy in the solution can be up to 10 wt %, as long as they are fully/mostly dissolved in the solvent. The mass ratio of lignin to epoxy can vary from 10:1 to 1:1. Second, the solution is mixed with a non-solvent of water, preferably rapid mixing (e.g. preferably less than 1 s) under vortex stirring of water. Afterwards, the organic solvent can be removed by separation methods such as dialysis against water or evaporation. In case of evaporation, the temperature should be controlled at or below room temperature (23° C.) to avoid reaction of lignin and epoxy, the pressure can be adjusted as long as it is below the vapor pressure of the organic solvent, e.g. <270 mbar for acetone at 23° C. Thus, a preferred evaporation temperature is within the range of 15-23° C.

In one embodiment, the concentration of the prepared aqueous hy-LNP dispersions can be adjusted by e.g. centrifugation, evaporation and water addition. Typically, one or more of said techniques are used, preferably two or all three of these.

In one embodiment, the hy-LNP dispersion can be dried, for instance, by low-temperature spray drying or freeze-drying for storage and transportation. The dry hy-LNP can be redispersed in water before use. Hot spray drying should be avoided to prevent the reaction of lignin and epoxy. If pH needs to be adjusted, it is recommended to control the pH between 3 and 10 to avoid precipitation or dissolution of the particles.

In the embodiment of technical adhesives, the mass ratio of lignin to epoxy needs to be from 10:1 to 1:1 for SKL and BADGE, preferably at 7:3. The adhesives can be used to glue various materials, for instance, wood, ceramics and metals. The concentration of the aqueous hy-LNP dispersion (waterborne adhesive) should be relative high, e.g. at 40 wt % of the solid content to achieve a good adhesive strength. The curing temperature is pH dependent. If the curing is done at the native pH of the dispersion (e.g. at pH 4), the curing temperature at ambient pressure needs to be at or above 160° C., as high temperature can extrude the epoxy out of the particles to achieve both inter- and intraparticle cross-inking reactions. Lower curing temperature can be achieved at a higher pH, e.g. from pH 7 to 10. However, the pH adjustment needs to be done right before the use to avoid significant reaction of lignin and epoxy before applying to the substrate. If the adhesive is stored in dispersion state, it needs to be stored at a low temperature, e.g. at 4° C. The lower the storage temperature, the longer time the adhesive can be stored. If the adhesive is stored in dry state, it can be stored at room temperature. Water behaves also as a catalyst for the reaction between lignin and epoxy.

In the embodiment of covalent surface functionalization of the hy-LNPs, the mass ratio of lignin to epoxy needs to be from 9:1 to 1:1 for SKL and BADGE, preferably at 4:1. Before covalent surface functionalization of the hy-LNPs, the hy-LNPs needs to be intraparticlely cross-linked. The intraparticle cross-linking can be done at an elevated temperature, e.g. from 90 to 120° C., at the native pH (4 to 6) of the hy-LNP dispersion. Or at a low curing temperature, e.g. from 30 to 90° C. at the pH between 7 and 10. Or at room temperature at pH 12, yet it needs to be emphasized that at pH 12 the particles are partially dissolved, the estimated solubility is <40%. In short summary, the curing temperature is pH dependent, the higher the pH, a lower curing temperature is needed. Meanwhile, the higher the curing temperature, the shorter the curing time is required. For instance, at 105° C., the curing is completed within 4 hours for the hy-LNPs (SKL:BADGE=4:1).

In the embodiment of covalent cationization of the cured hy-LNPs, the reaction can be done via the epoxy ring-opening chemistry under strongly alkaline conditions. For instance, glycidyl trimethylammonium chloride (GTMA) can be used for the reaction. The reaction can be conducted e.g. at pH 12 following the procedure described in literature (see Kong, F. et al.). Thus, a particularly preferred method of carrying out covalent cationization is to use GTMA in an epoxy ring-opening that proceeds at 70° C. for 1 h, and at said pH, or the temperature can be lower, such as ≥40° C., and the time longer, such as up to 5 h, or the pH can vary between 11 and 12.5. The molar ratio of GTMA/lignin is preferably 2/1, while the lignin concentration preferably is 1.0 w-%.

### EXAMPLES

### Example 1. Preparation and Characterization of the Aqueous Lignin-Epoxy Hy-LNP Dispersions

In this example, the used lignin was softwood Kraft lignin (SKL), which was obtained from UPM (Finland). The SKL has the trade name of BioPiva 100, which is purified from black liquor using LignoBoost@ technology. The number average molecular weight and weight average molecular weight of SKL are 693 and 4630 g/mol respectively, determined with gel permeation chromatography. The aliphatic hydroxyl groups, phenolic hydroxyl groups and carboxylic hydroxyl groups of the SKL are 2.05, 4.07 and 0.44 mmol/g respectively, determined with Phosphorus-31 nuclear magnetic resonance. Bisphenol A diglycidyl ether (BADGE) is purchased from Sigma-Aldrich.

The aqueous hy-LNPs were prepared by replacing SKL partially with BADGE but otherwise following the same procedure for preparing LNPs as described earlier (see Zou, T. et al.). In detail, SKL and BADGE (total weight of 1 g) with the weight percentage of BADGE to SKL varying between 10 and 50 wt % (or mass ratio of SKL to BADGE from 9:1 to 1:1) were first co-dissolved in 100 g of acetone-water (3:1, w/w) under magnetic stirring for 3 hours. Undissolved residues were removed by filtering the solutions through paper filters (Whatman, pore size 0.7 μm). Afterwards, the solutions were poured rapidly (in less than 1 s) into vortex-stirring deionized water (solution:water=1:2.5, w/w), a process which formed hy-LNPs instantly. Acetone was removed by dialyzing the particle dispersions against DI water using a Spectra/Por® 1 tubing with a molecular-weight-cut-off (MWCO) of 6-8 kg/mol.

Table 1 shows the preparation parameters, final obtained concentrations and yields of the BADGE-SKL hybrid LNPs and the regular LNPs.

TABLE 1

| | Weight | Initial total | Final obtained | |
|---|---|---|---|---|
| | percentage | concentration | concentration | |
| | of BADGE | of BADGE and | of the particles | |
| | relative to SKL | SKL solution | in water | Yield |
| Sample code | (wt %) | (wt %) | (wt %) | (wt %) |
| LNPs | 0 | 1 | 0.23 | 85.3 |
| hy-LNPs10 | 10 | 1 | 0.19 | 78.8 |
| hy-LNPs20 | 20 | 1 | 0.21 ± 0.01^{a} | 79.3 ± 2.2^{a} |
| hy-LNPs30 | 30 | 1 | 0.20 ± 0.01^{a} | 72.5 ± 3.7^{a} |
| hy-LNPs40 | 40 | 1 | 0.19 ± 0.01^{a} | 70.1 ± 3.0^{a} |
| hy-LNPs50 | 50 | 1 | 0.19 ± 0.02^{a} | 69.8 ± 0.7^{a} |

^{a}Mean value ± absolute deviation of two batches. The pH values of all the final obtained aqueous dispersions were between 4 and 5.

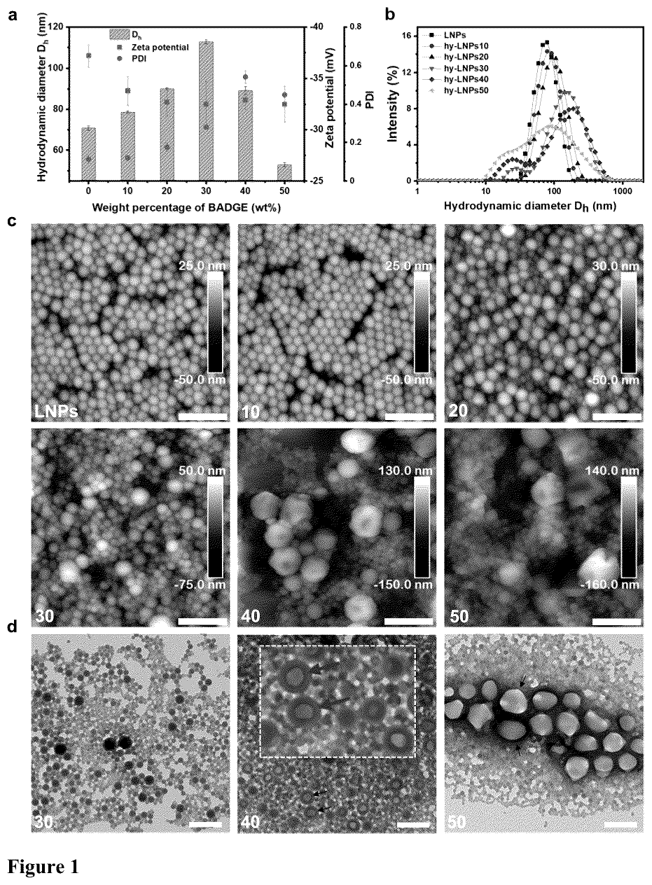

FIG. 1 shows the morphologies, hydrodynamic diameters and zeta potentials of the various hy-LNPs (10 to 50 wt % BADGE) and the regular hy-LNPs. The hydrodynamic diameters (Dₕ, also called Z-average size) and zeta potentials were measured at the native concentration (˜0.2 wt %) and diluted concentration (˜0.02 wt %, diluted 10 times with deionized water) of the dispersions respectively, a Zetasizer Nano ZS90 instrument (Malvern Instruments Ltd., U.K.) was adapted for the measurement. The pH of the diluted dispersions varied between 5 and 6. Average values of three replicates of the Dh and zeta potentials were used in the analysis and reporting of data. A MultiMode 8 atomic force microscope (AFM) equipped with a NanoScope V controller (Bruker Corporation, U.S.A.) was used to take the AFM images. Transmission electron microscopic (TEM) images of the hy-LNPs were obtained in bright-field mode on a FEI Tecnai 12 (USA) operating at 120 kV.

### Example 2. Intraparticle Cross-Linking of Hy-LNPs20 in Dispersion State

The intraparticle cross-linking of hy-LNPs20 was conducted at 105° C. in dispersion state at their native pH of 5, in detail ca. 20 ml of hy-LNPs20 dispersion was sealed in a glass bottle and placed in an oven for the intraparticle cross-linking. A complete cross-linking reaction was achieved within 4 hours.

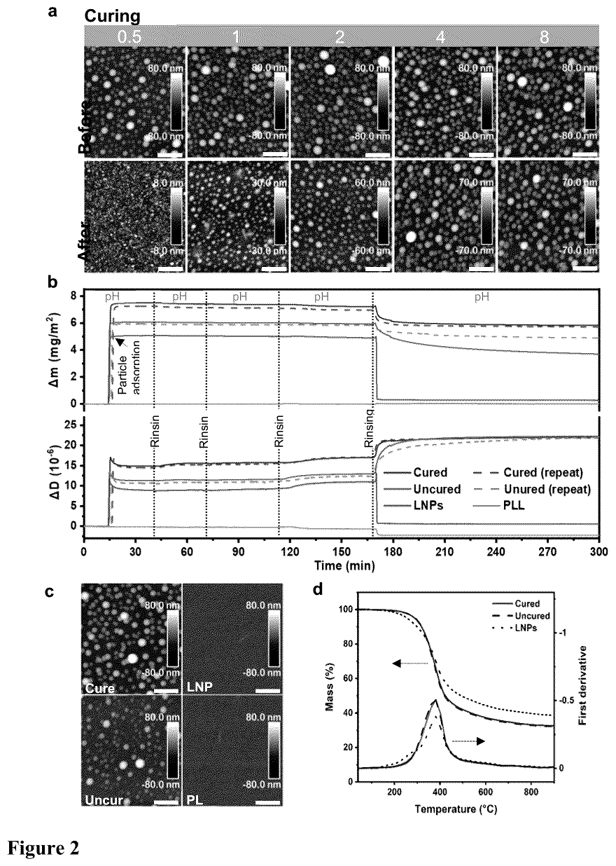

FIG. 2 shows solvent-resistance and thermal stabilities of the 0.5 to 8 hour-cured hy-LNPs20. The 4 h cured particles withheld their integrities after rinsing with acetone-water (3:1, w/w) in contrast to the particles cured for shorter times that showed clear reduction in size. In addition, the 4 h cured particles (shorted as cured particles in the figure) exhibited ˜20% reduction in sensed mass at pH 12 as detected by quartz crystal microbalance with dissipation monitoring, whereas regular LNPs showed a sharp reduction in sensed mass back to around zero. Atomic force microscopic images confirmed the pH-resistance of the cured hy-LNPs20, and a complete dissolution of the regular LNPs at pH 12. Moreover, the cured hy-LNPs20 exhibited significantly higher T_{5%} (5% mass loss) of 290° C. compared to the T_{5%} of 256° C. for the regular LNPs. The uncured hy-LNPs20 showed similar thermal stability as the cured hy-LNPs20 due to curing upon heat treatment.

### Example 3. Cationization of the Cured Hy-LNPs20

Hy-LNPs20 cured for 4 h at 105° C. in dispersion state were chosen for covalent cationization reaction. The cationization of the cured particles followed a similar procedure as the cationization of Kraft lignin described in the literature. In brief, the pH of the cured hy-LNP20 aqueous-dispersion (5 ml) was first tuned to be alkaline (11.7) by adding 0.5 ml of 0.1 mol/L sodium hydroxide. Then, 28.1 mg of glycidyl trimethylammonium chloride (GTMA) was added dropwise to the dispersion. The cationization was conducted at 70° C. for 1 hour under stirring. After which, dialysis using a Spectra/Por® 1 tubing with a molecular-weight-cut-off (MWCO) of 6-8 kg/mol was applied to the dispersion to remove sodium hydroxide and the unreacted GTMA, the dialysis was continued until the pH reached around 7.

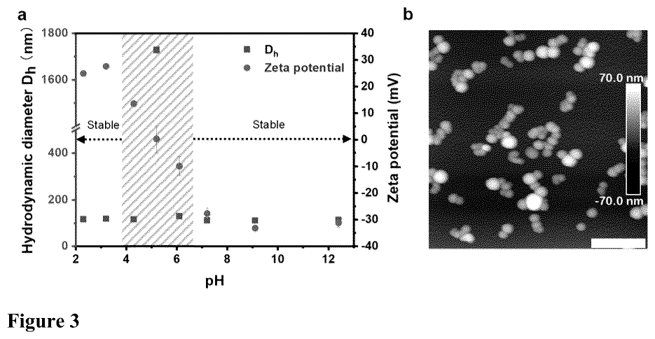

FIG. 3 shows the pH-switchable surface charge of the cationized particles. The size of the cationized particles was similar to that before cationization as indicated by the atomic force microscopic images.

### Example 4. Curing of the Aqueous Hy-LNPs30 Dispersion for Wood Adhesive

Concentrated hy-LNPs30 aqueous dispersion (˜41 wt % solid content) obtained from the sediment after centrifugation (11000 rpm for 30 min) was used for the adhesive analysis. Birch veneers with the size of 11.5×2×0.15 cm³ were loaded with the hy-LNPs30 dispersion over an area of 1 cm² using two different loading concentrations (˜0.10 and ˜0.27 kg/m²). Then the veneers were paired and hot-pressed at 160° C. and 0.7 MPa for 10 minutes to prepare the samples for adhesive strength test. A commercial multi-purpose epoxy adhesive comprising of an epoxy resin and a hardener purchased from Loctite was used as reference. After applying ˜0.20 kg/m 2 of the commercial epoxy adhesive to the veneers, the veneers were pressed at 0.7 MPa for 20 min and then allowed to be cured for 24 h at room temperature. The adhesive strength analysis was performed on an automated bonding evaluation system (ABES) (Adhesive Evaluation Systems Inc, United States). The wet adhesive strength was measured after soaking of the cured veneers in deionized water (at room temperature) for 48 h. Three identically prepared samples were measured.

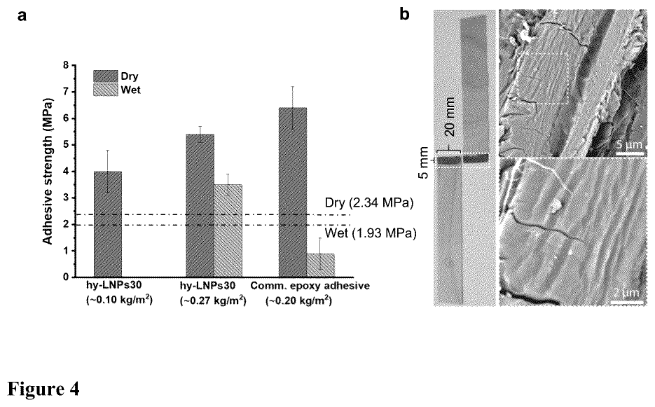

FIG. 4 shows the dry and wet adhesive strength of the hy-LNPs30-based waterborne adhesive (41 wt % solid content) and a commercial epoxy adhesive from Loctite for birch veneers (11.5×2×0.15 cm³). Mean±standard error of three replica are shown. The dashed lines denote the minimum dry/wet adhesive strength requirements for urea-formaldehyde type adhesive according to ASTM-D4690. After curing the hy-LNPs30 formed thermoset as indicated by the scanning electron microscopic images.

### REFERENCES

(1) Podschun, J.; Stücker, A.; Buchholz, R. I.; Heitmann, M.; Schreiber, A.; Saake, B.; Lehnen, R. Phenolated Lignins as Reactive Precursors in Wood Veneer and Particleboard Adhesion. Ind. Eng. Chem. Res. 2016, 55 (18), 5231-5237. https://doi.org/10.1021/acs.iecr.6b00594
(2) Kalami, S.; Arefmanesh, M.; Master, E.; Nejad, M. Replacing 100% of Phenol in Phenolic Adhesive Formulations with Lignin. Journal of Applied Polymer Science 2017, 134 (30), 45124. https://doi.org/10.1002/app.45124
(3) Jablonskis, A.; Arshanitsa, A.; Arnautov, A.; Telysheva, G.; Evtuguin, D. Evaluation of Ligno Boost™ Softwood Kraft Lignin Epoxidation as an Approach for Its Application in Cured Epoxy Resins. Industrial Crops and Products 2018, 112, 225-235. https://doi.org/10.1016/j.indcrop.2017.12.003
(4) Zhang, Y.; Pang, H.; Wei, D.; Li, J.; Li, S.; Lin, X.; Wang, F.; Liao, B. Preparation and Characterization of Chemical Grouting Derived from Lignin Epoxy Resin. European Polymer Journal 2019. https://doi.org/10.1016/j.eurpolymj0.2019.05.003
(5) Ott, M. W.; Dietz, C.; Trosien, S.; Mehlhase, S.; Bitsch, M. J.; Nau, M.; Meckel, T.; Geissler, A.; Siegert, G.; Huong, J.; Hertel, B.; Stark, R. W.; Biesalski, M. Co-Curing of Epoxy Resins with Aminated Lignins: Insights into the Role of Lignin Homo Crosslinking during Lignin Amination on the Elastic Properties. Holzforschung 2020, 1 (ahead-of-print). https://doi.org/10.1515/hf-2020-0060
(6) Gioia, C.; Colonna, M.; Tagami, A.; Medina, L.; Sevastyanova, O.; Berglund, L. A.; Lawoko, M. Lignin-Based Epoxy Resins: Unravelling the Relationship between Structure and Material Properties. Biomacromolecules 2020, 21 (5), 1920-1928. https://doi.org/10.1021/acs.biomac.0c00057
(7) Jingxian Li, R.; Gutierrez, J.; Chung, Y.-L.; W. Frank, C.; L. Billington, S.; S. Sattely, E. A Lignin-Epoxy Resin Derived from Biomass as an Alternative to Formaldehyde-Based Wood Adhesives. Green Chemistry 2018, 20 (7), 1459-1466. https://doi.org/10.1039/C7GC03026F
(8) DENCHOKPRAGUY, N.; Champreda, V.; LAOSIRIPOJANA, N. A Pretreatment Process of Lignocellulosic Biomass. WO2016053209A1, Apr. 7, 2016.
(9) Henn, A. Lignin Nanoparticles and Epoxies for the Preparation of Durable and Highly Bio-Based Surface Coatings and Adhesives, 2020
(10) Frihart, C. R. Adhesive Groups and How They Relate to the Durability of Bonded Wood. Journal of Adhesion Science and Technology 2009, 23 (4), 601-617. https://doi.org/10.1163/156856108X379137
(11) Lievonen, M.; Valle-Delgado, J. J.; Mattinen, M.-L.; Hult, E.-L.; Lintinen, K.; Kostiainen, M. A.; Paananen, A.; Szilvay, G. R.; Setala, H.; Österberg, M. A Simple Process for Lignin Nanoparticle Preparation. Green Chemistry 2016, 18 (5), 1416-1422. https://doi.org/10.1039/C5GC01436K
(12) Sameni, J.; Krigstin, S.; Sain, M. Solubility of Lignin and Acetylated Lignin in Organic Solvents. BioResources 2017, 12 (1), 1548-1565
(13) Richter, A. P.; Bharti, B.; Armstrong, H. B.; Brown, J. S.; Plemmons, D.; Paunov, V. N.; Stoyanov, S. D.; Velev, O. D. Synthesis and Characterization of Biodegradable Lignin Nanoparticles with Tunable Surface Properties. Langmuir 2016, 32 (25), 6468-6477. https://doi.org/10.1021/acs.langmuir.6b01088
(14) Sipponen, M. H.; Smyth, M.; Leskinen, T.; Johansson, L.-S.; Österberg, M. All-Lignin Approach to Prepare Cationic Colloidal Lignin Particles: Stabilization of Durable Pickering Emulsions. Green Chemistry 2017, 19 (24), 5831-5840. https://doi.org/10.1039/C7GC02900D
(15) Zou, T.; Sipponen, M. H.; Osterberg, M. Natural Shape-Retaining Microcapsules With Shells Made of Chitosan-Coated Colloidal Lignin Particles. Front. Chem. 2019, 7. https://doi.org/10.3389/fchem.2019.00370
(16) Sipponen, M. H.; Farooq, M.; Koivisto, J.; Pellis, A.; Seitsonen, J.; Osterberg, M. Spatially Confined Lignin Nanospheres for Biocatalytic Ester Synthesis in Aqueous Media. Nat Commun 2018, 9. https://doi.org/10.1038/s41467-018-04715-6
(17) Rivière, G. N.; Korpi, A.; Sipponen, M. H.; Zou, T.; Kostiainen, M. A.; Osterberg, M. Agglomeration of Viruses by Cationic Lignin Particles for Facilitated Water Purification. ACS Sustainable Chem. Eng. 2020. https://doi.org/10.1021/acssuschemeng.9b06915
(18) Kong, F.; Parhiala, K.; Wang, S.; Fatehi, P. Preparation of Cationic Softwood Kraft Lignin and Its Application in Dye Removal. European Polymer Journal 2015, 67, 335-345. https://doi.org/10.1016/j.eurpolymj.2015.04.004

What Customer's Problem does Your Invention/Idea Solve?

Petroleum-based formaldehyde adhesive has been dominating the wood adhesive market. However, formaldehyde has the toxicity and environmental problems, and petroleum is a non-renewable source.

Today, our society is transiting to a stronger, circular and low-carbon economy, namely bioeconomy that launched by European Commission, which requires a greater and more sustainable use of natural resources by sustainably increasing the primary production and conversion of waste into value-added products, enhanced production and resource efficiency.

Lignin is considered as non-toxic, environmentally friendly, renewable and abundant material extracted from plant, which however has been mainly regarded as a waste or low energy source. Therefore, the valorization of lignin for wood adhesive meets the bioeconomy strategy.

Some studies have reported the lignin-based wood adhesives, however, those systems have the limitations of pre-fractionation/modification/functionalization of lignin, time-consuming and/or multistep processing. On the other hand, the resulted mechanical performance (e.g. adhesive strength) often encounter the issue of low water resistance, which is thus not comparable to the commercial adhesives.

2. How does Your Invention/Idea Solve the Problem?

In general, our adhesive is a relative green product. Except the use of low toxic commercial BADGE (only 8 wt %), the rest components are 32 wt % SKL and 60 wt % water. Compared to commercial or other lignin-based adhesives, our adhesive has the advantages of:
1. Lignin is a renewable and non-toxic product, which is used as such without pre-fractionation/modification/functionalization.
2. The production route of the adhesive is simple and green, the only needed chemical is acetone which can be recycled.
3. The adhesive is formulated in an all-in-one manner, which can be directly applied to the wood surface without pre-mixing or stepwise spreading.
4. The adhesive is a waterborne adhesive, which can be easily spread on the surface of wood due to low viscosity of water.
5. Relative short curing time (10 min, can be further modified), and the adhesive exhibits strong water resistance and thus sufficiently high wet adhesive strength after curing. More details about the adhesive strength can be found in the annex.

3. What are the Benefits to the Customer?

Our invention meets the scope of bioeconomy strategy. The benefits of our product compared to other wood adhesives has been mentioned above.

5. How Big is the Entire Market? how Much is it Growing Annually in the Future? Describe Your Assumed First Customer?

The global epoxy adhesives market size is estimated to be USD 7.2 billion in 2019 and projected to reach USD 9.6 billion by 2024, at a CAGR of 6.0% (https://www.marketsandmarkets.com/Market-Reports/epoxy-adhesive-market-142980020.html?gclid=CjOKCQjw4f35BRDBARIsAPePBHyL3To149YpXT7tccTZo2YTWpGrZToExhGs-Ep18EiinvKdy0B-xxEaAvr2EALw_wcB).

The global wood adhesives market size was valued at USD 4.60 billion in 2018 and is predicted to grow at a CAGR of 4.7% from 2019 to 2025 (https://www.grandviewresearch.com/industry-analysis/wood-adhesives-market#:˜:text=The%20g1obal%20wood%20adhesives%20market,4.7%25%20from%202 019%20to%202025.&text=Engineered%20wood%2dbased%20panels%20such,adhesives %20during%20their′)/020manufacturing%20process.).

Our first customer can be a paper and pulp company, e.g. Stora Enso.

6. How is the Problem Solved Currently? What are the Substituting Competitors (Companies, Products, Technology)? how are You Different from the Competitors?

Currently there are some lignin-based adhesives on the market, but they are based on chemical modification of lignin, or still not competitive with respect to wet strength to phenol formaldehyde-based resins or substitute only part of phenol formaldehyde with lignin. Within Aalto there are also other patents related to colloidal lignin particle-based adhesives, but this is a different approach that complements the other ones.

1-19. (canceled)

20. A method of forming lignin-epoxy hybrid nanoparticles, wherein softwood Kraft lignin (SKL) is mixed with bisphenol A diglycidyl ether (BADGE), in solution state in a solvent, and co-precipitated by reducing the solvent concentration in the mixture, to give rise to hybrid nanoparticles (hy-LNPs) in a dispersion.

21. The method of claim 20, wherein the softwood Kraft lignin (SKL) has been purified from black liquor.

22. The method of claim 20, wherein the solvent consists of acetone.

23. The method of claim 20, wherein the hy-LNPs are prepared by nanoprecipitation with a mass ratio of lignin to bisphenol A diglycidyl ether being from 10:1 to 1:1.

24. The method of claim 20, wherein the hy-LNPs are prepared by mixing the mixture into water in less than 1 second under vortex stirring.

25. The method of claim 20, wherein the solvent is removed from the mixture by dialysis against water or evaporation.

26. The method of claim 20, wherein undissolved residues are removed by filtering after mixing the lignin and the bisphenol A diglycidyl ether into the solvent.

27. The method of claim 20, wherein the hy-LNPs are either intraparticle-crosslinked for covalent surface functionalization or inter- and intraparticle cross-linked.

28. The method of claim 20, wherein the concentration of the prepared hy-LNP dispersion is adjusted by centrifugation, evaporation or water addition.

29. The method of claim 20, wherein the formed hy-LNP dispersion is dried by spray drying or freeze drying for storage and transportation.

30. The method of claim 20, wherein the mass ratio of lignin to epoxy in the hy-LNP dispersion is from 10:1 to 1:1.

31. The method of claim 20, further comprising curing the hy-LNP dispersion.

32. The method of claim 20, further comprising subjecting the hy-LNPs to covalent cationization to provide quaternary ammonium groups on the hy-LNPs.

33. The method of claim 32, further comprising cross-linking the hy-LNPs at a temperature from 90 to 120° C. at a pH of 4 to 6 of the hy-LNP dispersion, or at a curing temperature from 30 to 90° C. at a pH between 7 and 10, or at room temperature at pH 12.

34. The method of claim 32, wherein the covalent cationization is carried out by epoxy ring-opening chemistry of hy-LNPs at a pH>10with glycidyl trimethylammonium chloride (GTMA).

35. The method of claim 20, wherein the mass ratio of lignin to epoxy is from 9:1 to 1:1 in the covalent cationization.

36. The method of claim 20, wherein the concentration of BADGE in the formed hy-LNPs is less than or equal to 20 wt %.

37. A method of forming lignin-epoxy hybrid nanoparticles, the method comprising:
(a) mixing softwood Kraft lignin (SKL), and epoxy resin, and a solvent comprising an organic solvent to form a solution of the softwood Kraft lignin and epoxy; and
(b) after step (a), mixing the formed solution into water to form the lignin-epoxy hybrid nanoparticles.
